(19) United States
(12) Patent Application Publication
(10) Pub. No.: US 2017/0137914 A1
(43) Pub. Date: May 18, 2017

(54) MERCURY REMOVAL

(71) Applicant: JOHNSON MATTHEY PUBLIC LIMITED COMPANY, London (GB)

(72) Inventor: James George STEVENS, BERKSHIRE (GB)

(73) Assignee: JOHNSON MATTHEY PUBLIC LIMITED COMPANY, London (GB)

(21) Appl. No.: 15/129,742

(22) PCT Filed: Mar. 31, 2015
(86) PCT No.: PCT/GB2015/050977

§ 371 Date: Sep. 27, 2016

(30) Foreign Application Priority Data
Apr. 2, 2014 (GB) 1405888.7

(51) Int. Cl. C22B 43/00; C22B 11/08; B01J 20/32; C02F 1/28; B01J 20/26; B01J 20/22; C22B 3/00; C22B 3/24

(52) U.S. Cl. CPC C22B 43/00; C22B 11/04; C22B 11/08; C22B 3/24; C02F 1/285; B01J 20/265; B01J 20/22; B01J 20/3204; B01J 20/321; B01J 20/3219; B01J 20/3248; C02F 2101/20

(57) ABSTRACT

Disclosed is selective removal of mercury from aqueous feeds also including precious metals. In particular, the present invention is useful for removal of mercury from processing waters produced during precious metal mining processes. The process includes contacting the aqueous feed solution with a solid sorbent material including thiol and/or thiolate functional groups, wherein (i) the aqueous feed solution includes at least 10 ppm of free cyanide ions; and/or (ii) the sorbent material is contacted with an aqueous cyanide solution after contact with the aqueous feed solution to selectively desorb precious metal from the sorbent material.

### FIELD OF THE INVENTION

The present invention relates to selective removal of mercury from aqueous feeds also comprising precious metals. In particular, the present invention is useful for removal of mercury from processing waters produced during precious metal mining processes.

### BACKGROUND OF THE INVENTION

In modern gold mining processes, typically it is necessary to extract gold from complex ores which comprise gold in addition to other metals, including mercury. A common technique for extracting gold from its ores is the cyanide process, wherein leaching of gold is achieved by the addition of cyanide at alkaline pH. Cyanide is a strong lixiviant for gold, and so leaches the gold out of the ore into solution. The gold is typically present in the leaching solution as a gold cyanide complex such as [Au(CN)₂]⁻¹. Silver can also be extracted from its ores using a similar cyanide leaching process.

A problem with this process is that cyanide is an equally strong lixiviant for mercury as it is for gold and silver. Accordingly mercury, which is typically present in the ore along with gold or silver, is also leached into the solution. The mercury may be present in the leaching solution for example as Hg(CN)₂, [Hg(CN)₃]⁻¹ or [Hg(CN)₄]⁻². However, typically it is present as [Hg(CN)₄]⁻².

The removal of mercury from mining waters is very important, both on health and safety grounds and on environmental grounds. In particular, mercury volatilisation during extraction processes can be a threat to the health of plant workers, and the presence of mercury in waste waters from mining is of significant environmental concern. Environmental legislation limits the concentration of mercury permitted in waste waters to very low levels in many countries. Accordingly, effective removal of mercury from mining waters is of significant interest to the industry. However, it is important that mercury removal technologies do not remove significant quantities of the gold or silver being mined, to avoid undesirable loss of these materials during processing.

A range of different methods have been employed for mercury removal in this field. Reference 1 provides a review of different removal technologies, including precipitation with inorganic sulphides or sulphur-based organic compounds; adsorption with activated carbon or crumb rubber; solvent extraction by alkyl phosphorus esters or thiol extractants; ion exchange with isothiouronium groups, thiol resin or polystyrene-supported phosphinic acid; and electrochemical cementation.

Reference 2 describes the removal of mercury from mercury cyanide complexes from the processing streams of gold cyanidation circuits by dissolved air flotation at a laboratory scale. Selective aggregation of mercury was carried out after precipitation of the complexes with sodium dimethyl dithiocarbamate (NaDTC), coagulation with colloidal hydroxides of La and Fe, and flocculation with a polymer. Removal of mercury was achieved by dissolved air flotation of the aggregates formed.

U.S. Pat. No. 5,599,515 describes a method for selectively removing mercury from solutions, preferably solutions containing gold, such as gold cyanide solutions. The method comprises treating the solutions with dialkyldithiocarbamates, preferably potassium dimethyldithiocarbamate, to form stable mercury carbamate precipitates.

Reference 3 describes precipitation of mercury from heap leach solution using a dipotassium salt of 1,3-benzenediamidoethanethiol (BDET²⁻).

### SUMMARY OF THE INVENTION

There remains a need for improved methods for the selective removal of mercury from precious-metal containing aqueous feeds. In particular, the remains a need for methods which reduce the mercury levels in aqueous feeds to very low levels, without significant loss of precious metal. Additionally, there remains a need for mercury removal methods which can be conveniently incorporated into precious metal treatment processes, e.g. mining processes.

The present inventors have found that sorbent materials comprising thiol or thiolate functional groups will readily sorb (e.g. adsorb) mercury from aqueous solutions containing precious metals. As demonstrated in the Examples below, the presence of excess cyanide ions reduces or avoids sorption of precious metals by the thiol- or thiolate-containing sorbent material. As demonstrated in the Examples, excess cyanide ions may be provided in the mercury and precious-metal containing aqueous feed itself to avoid sorption of precious metals, or may be supplied to the sorbent after contact with the aqueous feed to release sorbed precious metals.

Accordingly, in a first preferred aspect, the present invention provides a process for selectively removing mercury from an aqueous feed solution, the aqueous feed solution comprising mercury in addition to one or more precious metals,

wherein the process comprises contacting the aqueous feed solution with a solid sorbent material comprising thiol and/or thiolate functional groups, wherein
(i) the aqueous feed solution comprises at least 10 ppm of free cyanide ions; and/or
(ii) the sorbent material is contacted with an aqueous cyanide solution after contact with the aqueous feed solution to selectively desorb precious metal from the sorbent material.

In a second preferred aspect, the present invention provides use of a sorbent material comprising thiol and/or thiolate functional groups for selectively removing mercury from an aqueous feed solution. The aqueous feed solution typically further comprises one or more other metals, such as one or more precious metals.

### BRIEF DESCRIPTION OF THE DRAWINGS

FIGS. 1, 2 and 3 show the results of adsorption tests for adsorbents 1, 2 and 3 for model solutions, as determined in Example 1.

FIGS. 4, 5 and 6 show the results of adsorption tests for adsorbents 1, 2 and 3 for model solutions, in the presence of certain additives including NaCN, as determined in Example 2.

FIGS. 7 and 8 show the results of adsorption tests for adsorbents 1 and 2 for model solutions including Ni, as determined in Example 3.

FIG. 9 shows the desorption of Au following addition of NaCN as determined in Example 4.

FIGS. 10 and 11 show the effect on adsorption of adding NaCN to a real mining solution as determined in Example 5.

FIG. 12 shows adsorption of Au, Ag and Hg as determined in Example 6.

FIGS. 13 to 16 show adsorption and elution of Au and Hg in a column comprising Adsorbent 1, as determined in Example 7.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The aqueous feed solution comprises mercury and one or more precious metals. As the skilled person will understand, the term precious metals includes gold, silver and the platinum group metals (which are platinum, palladium, rhodium, iridium, osmium and ruthenium). The process of the present invention is particularly effective for selective removal of mercury from an aqueous feed solution comprising gold and/or silver, as demonstrated in the Examples.

The process of the present invention is particularly suitable for selectively removing mercury from a cyanide solution. Accordingly, it will be understood that the mercury may be present in the aqueous feed solution as a mercury cyanide complex. Similarly, it will be understood that the precious metal may be present in the aqueous feed solution as a precious metal cyanide complex. As the skilled person will readily understand, a metal cyanide complex comprises a central metal atom having one or more cyanide ligands coordinated thereto. For example, the mercury cyanide complex may be selected from Hg(CN)₂, [Hg(CN)₃]⁻¹ and [Hg(CN)₄]⁻². Similarly, the precious metal (PM) cyanide complex may be selected from PM^{I}(CN), [PM^{I}(CN)₂]⁻¹ and [PM^{III}(CN)₄]⁻¹. Analysis by the inventors of actual process solutions from mines suggest that the mercury is typically present as [Hg(CN)₄]⁻², that gold (if present) is typically present as [AuCN)₂]⁻¹ and that silver (if present) is typically present as [AgCN)₂]⁻¹. However, as the skilled person will readily understand, the nature of the metal cyanide complexes is not particularly limited in the present invention. Even for a single metal, one or more different metal cyanide complexes may exist simultaneously in the aqueous feed solution.

Where the metal cyanide complex is charged, the nature of the counter ion is not particularly limited. Typically the counter ions will be positively charged metal ions, such as alkali metal ions or alkaline earth metal ions. For example, the counter ions may be one or more of Na⁺, K⁺ and Ca²⁺.

Conveniently, the process of the present invention is particularly suitable for selectively removing mercury from processing waters for gold and/or silver cyanidation processes typically employed to extract gold and/or silver from their ores. For example, the aqueous feed solution may by the solution produced directly from a cyanide heap leach step, or it may have been subjected to further processing following the leach step, such as contact with activated carbon. The process of the present invention is particularly suitable for selectively removing mercury from processing waters prior to an electrowinning step, e.g. immediately prior to an electrowinning step. As the skilled person will understand, electrowinning refers to electrodeposition of metal from a solution, typically metal which has been extracted from its ore into the solution.

In the methods of the present invention, the aqueous feed solution may include free cyanide ions. The term free cyanide ions is intended to include cyanide ions which are not part of metal cyanide complexes or other coordination complexes in the aqueous feed solution. For example, free cyanide ions may include cyanide ions which have been solvated by water.

Without wishing to be bound by theory, the present inventors believe that the reason for the improvement in selectivity they have observed on exposure of the sorbent materials to free cyanide ions may be a result of the free cyanide ions affecting the equilibrium between precious metal-thiol complexes which form when the precious metal is sorbed onto the sorbent material, and precious metal cyanide complexes which are present in solution. In the case of gold, the equilibrium may be illustrated as:

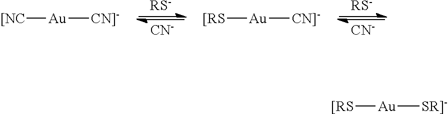

Species having only CN⁻ ligands will be in the solution phase, whereas species with one or more thiol ligands will be sorbed onto the sorbent material, which includes a thiol or thiolate functional group. The presence of more cyanide ions in the solution will push the equilibrium towards the cyanide-only species, thereby reducing uptake of gold by the sorbent materials comprising thiol or thiolate functional groups.

However, as demonstrated in the Examples below, the present inventors have surprisingly found that the presence of free cyanide ions does not affect the analogous mercury thiol-cyanide equilibrium in the same way, and accordingly does not reduce the uptake of mercury from the aqueous feed solution. Thus the presence of free cyanide ions significantly enhances the selectivity of the sorbent materials for mercury over precious metals.

Where the free cyanide ions are present in the aqueous feed solution, preferably the aqueous feed solution includes at least 10 ppm of free cyanide ions. For example, it may include at least 20 ppm, at least 30 ppm, at least 40 ppm, at least 50 ppm, at least 60 ppm, at least 70 ppm, at least 80 ppm or at least 90 ppm of free cyanide ions. The upper limit on the concentration of free cyanide ions is not particularly limited in the present invention. The present inventors have found that even in the presence of 1000 ppm cyanide ions, the uptake of mercury by the sorbent materials is very high. Accordingly, the aqueous feed solution may comprise 10,000 ppm or less of free cyanide ions, 5000 ppm or less, 2500 ppm or less, 1500 ppm or less, 1000 ppm or less or 500 ppm or less of free cyanide ions. As used herein, ppm is intended to mean parts per million by mass, and ppb is intended to mean parts per billion by mass.

Similarly, where the sorbent material is contacted with an aqueous cyanide solution after contact with the aqueous feed solution to selectively desorb precious metal from the sorbent material, preferably the aqueous cyanide solution includes at least 10 ppm of cyanide ions. For example, it may include at least 20 ppm, at least 30 ppm, at least 40 ppm, at least 50 ppm, at least 60 ppm, at least 70 ppm, at least 80 ppm or at least 90 ppm of cyanide ions. The upper limit on the concentration of cyanide ions is not particularly limited in the present invention. The present inventors have found that even in the presence of 1000 ppm cyanide ions, mercury is not significantly desorbed. Accordingly, the aqueous feed solution may comprise 10,000 ppm or less of cyanide ions, 5000 ppm or less, 2500 ppm or less, 1500 ppm or less, 1000 ppm or less or 500 ppm or less. Typically, the cyanide ions present in the aqueous cyanide solution are free cyanide ions.

Where free cyanide ions are present in the aqueous feed solution, for example they may be added to the aqueous feed solution as a cyanide compound, such as a cyanide salt. Similarly, the aqueous cyanide solution may be prepared by adding a cyanide compound, such as a cyanide salt, to water. For example, the cyanide compound may be a metal cyanide salt, such as an alkali metal cyanide salt, or an alkaline earth metal cyanide salt. Particularly suitable are sodium cyanide and potassium cyanide.

As discussed above, the present invention is particularly suitable for selectively removing mercury from processing waters from mining processes, and in particular processing waters obtained after cyanidation of metal ores. In these processes, in order to leach metal from the ore, typically a concentrated cyanide leach solution is contacted with the ore. The solution acts as a lixiviant to draw the metal into solution. Accordingly, it will be understood that the processing waters produced following this leaching process may include free cyanide ions, where cyanide ions from the cyanide leach solution are not involved in complexes with the extracted metals. However, in practice the present inventors have found that real mining waters they have tested do not exhibit the excellent mercury selectivity provided by the present invention, without the addition of further cyanide. This is demonstrated in Example 5 below.

Without wishing to be bound by theory, the present inventors believe that this is because free cyanide ions present in the processing waters oxidise over time to form, for example, cyanate. This cyanate does not provide the same effect as cyanide ions in increasing selectivity for mercury over precious metals. However, as demonstrated in Example 5, the addition of cyanide ions to the real mining waters shortly before they are contacted with the sorbent material provides the excellent mercury selectivity of the present invention.

Accordingly, it may be preferred that the process includes a step of adding cyanide ions to the aqueous feed solution. For example, this could be before the aqueous feed solution is contacted with the sorbent material, or during its contact with the sorbent material (see Example 4). For example, the cyanide ions may be added less than 24 hours before contact with the sorbent material, less than 12 hours before contact with the sorbent material, less than 6 hours before contact with the sorbent material, less than 2 hours before contact with the sorbent material, less than 1 hour before contact with the sorbent material, less than 30 minutes before contact with the sorbent material or less than 10 minutes before contact with the sorbent material. Alternatively, where processing waters are treated using the methods of the present invention, steps may be taken to avoid oxidation of free cyanide ions in the processing waters prior to treatment. For example, the processing waters may be treated immediately after the heap leaching, so that there is insufficient time for the free cyanide ions to oxidise. In such cases, it may not be necessary to include an additional step of adding cyanide to the solution. However, as the skilled person will understand, what is important is that the free cyanide ions are present in the aqueous feed solution when it is contacted with the sorbent material, however this is achieved.

The way in which the aqueous feed solution is contacted with the sorbent material is not particularly limited in the present invention. A batch of aqueous feed solution may be contacted with a batch of sorbent material, and then separated from the sorbent material after adsorption of the mercury. Alternatively, the aqueous feed solution may be flowed over a bed of sorbent material. This may be particularly convenient as it enables continuous treatment of aqueous feed solution, which can be readily integrated into mining processes.

Similarly, where the sorbent material is contacted with an aqueous cyanide solution after contact with the aqueous feed solution, the method by which the aqueous cyanide solution is contacted with the sorbent material is not particularly limited. A batch of aqueous cyanide solution may be contacted with a batch of sorbent material, and then separated from the sorbent material after desorption of the precious metal. Alternatively, the aqueous cyanide solution may be flowed over a bed of sorbent material.

After contact with the sorbent material, the aqueous cyanide solution may be further processed to recover any precious metal desorbed from the sorbent material. For example, the aqueous cyanide solution comprising desorbed precious metal may be combined with treated aqueous feed solution and processed to recover the precious metal, for example using techniques known in the precious metal mining field.

To maximise recovery of the precious metal, it may be particularly advantageous that the aqueous feed solution comprises free cyanide ions to reduce adsorption of precious metal, and that the sorbent is contacted with aqueous cyanide solution after contact with the aqueous feed solution, to desorb any adsorbed precious metal.

When it is contacted with the sorbent material, the pH of the aqueous feed solution is preferably at least pH 6, at least pH7, at least pH8, at least pH9, at least pH10 or at least pH11. It may be pH15 or less, pH14 or less or pH13 or less. pHs in the range from pH9 to pH13 are particularly suitable.

The sorbent materials useful in the processes of the present invention comprise thiol and/or thiolate functional groups. It is believed that it is these thiol or thiolate functional groups which interact with the mercury to sorb (e.g. adsorb) it onto the sorbent materials. Typically, the sorbent materials will comprise mercury adsorbing moieties comprising thiol or thiolate functional groups, immobilised on a solid support. As the skilled person will understand, the sorbent materials are typically adsorbent materials.

The nature of the mercury adsorbing moieties is not particularly limited in the present invention. The mercury adsorbing moieties should comprise one or more thiol or thiolate functional groups. As the skilled person will understand, a thiol functional group is —SH, and a thiolate functional group is —S⁻, which is typically associated with a positively charged counter ion. For example, sodium thiolate is —S⁻Na⁺. Thiolate functional groups may be preferred where the sorbent material would otherwise be hydrophobic, as the presence of thiolate functional groups may enhance wetting by the aqueous feed solution and/or the aqueous cyanide solution.

For example, the mercury adsorbing moieties may have the structure of Formula I or Formula II below:

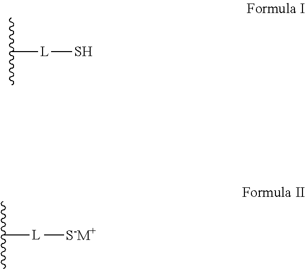

in which L is a linker group, and M⁺ is a counter ion, such as a metal counter ion. For example, it may be an alkali metal counter ion such as Na⁺ or K⁺. As the skilled person will understand, the wobbly line indicates attachment of the linker group to the solid support.

Preferably, the linker group is a non-hydrolysable linker group. The term non-hydrolysable linker group includes linker groups which are not typically hydrolysed under aqueous conditions. This means that the thiol or thiolate functional group is not readily detached from the solid support, in use.

The structure of the linker group is not particularly limited in the present invention. The linker group may be, for example, a C₁ to C₁₅ hydrocarbon moiety, optionally including one or more ether or thioether groups. The term hydrocarbon moiety is intended to include saturated or unsaturated, straight or branched optionally substituted hydrocarbon chains, optionally including one or more optionally substituted cyclic hydrocarbon groups, such as cycloalkylene, cycloalkenylene and arylene groups, including groups where one or more ring carbon atoms are replaced by a heteroatom, such as a heteroatom selected from O, N and S. As the skilled person will readily understand, the linker group is a divalent group attached both to the solid support and to the thiol or thiolate functional group.

For example, the linker group may be selected from:

—R₁—, wherein R₁ is C₁ to C₁₅ (e.g. C₁ to C₁₀ or C₁ to C₅) straight or branched, optionally substituted alkylene or alkenylene moiety;

—R₂—X—R₂—, wherein each R₂ is independently C₁ to C₁₀ (e.g. C₁ to C₅) straight or branched, optionally substituted alkylene or alkenylene moiety and wherein X is selected from O and S; and

—R₃—Y—R₃—, wherein each R₃ is independently present or absent and when present is independently selected from C₁ to C₁₀ (e.g. C₁ to C₅) straight or branched, optionally substituted alkylene or alkenylene moiety, and —R₄—X—R₄— wherein each R₄ is independently C₁ to C₅ (e.g. C₁ to C₃) straight or branched, optionally substituted alkylene or alkenylene moiety, wherein Y is selected from cycloalkylene, cycoalkenylene, arylene, in which one or more ring carbon atoms are replaced by a heteroatom selected from O, N and S, and wherein X is selected from O and S.

It may be preferred that R₁ is C₁ to C₁₀ branched or unbranched, optionally substituted alkylene or alkenylene moiety. It may be preferred that Y is selected from C₄ to C₆ cycloalkylene and C₄ to C₆ arylene. It may be preferred that X is O.

Suitable mercury adsorbing moieties include those according to one of Formula III, Formula IV or Formula IV below:

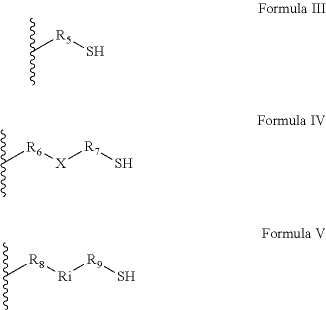

wherein:
each of R₅, R₆, and R₇, is independently C₁ to C₁₀ (e.g. C₁ to C₅) straight or branched alkylene or alkenylene, optionally substituted with up to four functional groups selected from —OR₁₀, —SR₁₀, —S⁻M⁺ and —NR₁₀R₁₀;
each R₈ and R₉ is independently selected from R₁₁—X—R₁₁ and C₁ to C₁₀ (e.g. C₁ to C₅) straight or branched alkylene or alkenylene, optionally substituted with up to four functional groups selected from —OR₁₀, —SR₁₀, —S⁻M⁺ and —NR₁₀R₁₀;
each R₁₀ is independently H or C₁ to C₅ alkyl;
each R₁₁ is independently C₁ to C₅ straight or branched alkylene or alkenylene, optionally substituted with up to four functional groups selected from —OR₁₀, —SR₁₀, —S⁻M⁺ and —NR₁₀R₁₀;
Ri is a C₅ or C₆ cycloalkyl, cycloalkenyl or aryl ring;
each X is independently S or O;
R₈ may optionally be absent;
R₉ may optionally be absent; and
any SH group may instead be S⁻M⁺, wherein M is a counter ion, such as a metal counter ion (e.g. alkali metal counter ion such as Na or K).

Further suitable mercury adsorbing moieties include those according to one of Formula VI, Formula VII or Formula VIII below:

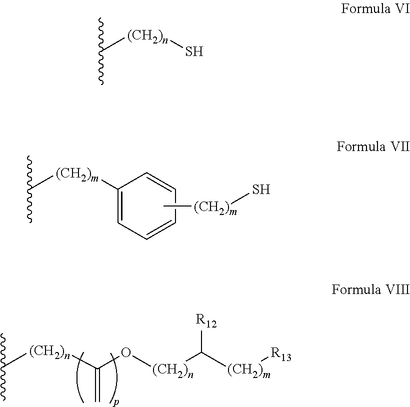

wherein:
each n is independently 1 to 10, more preferably 1 to 5 or 2 to 5;
each m is independently 0 to 10, more preferably 0 to 5, 0 to 3, 1 to 5, or 1 to 3;
R₁₂ and R₁₃ are each independently selected from SH, NH₂ or OH, provided that at least one of R₁₂ and R₁₃ is SH;
p is 0 or 1; and
any SH group may instead be S⁻M⁺ wherein M is a counter ion, such as a metal counter ion (e.g. alkali metal counter ion such as Na or K).

As used herein, the term optionally substituted includes moieties wherein one two, three, four or more hydrogen atoms have been replaced with other functional groups. Suitable functional groups include —OR₁₀, —SR₁₀, —S⁻M⁺ and —NR₁₀R₁₀ wherein each R₁₀ is independently H or C₁ to C₅ alkyl.

Examples of suitable mercury adsorbing moieties include:

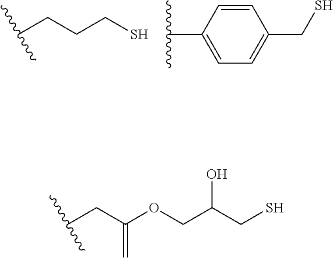

As discussed above, typically the sorbent materials of the present invention comprise mercury adsorbing moieties comprising thiol or thiolate functional groups, immobilised on a solid support. The nature of the solid support material is not particularly limited. Typically, the support material is in the form of particles such as powder, granules or fibres.

Where the support is a fibre, typically the fibre diameter (e.g. number average fibre diameter, e.g. determined by microscope counting of a representative sample of fibres) is about 0.05 mm. For example, the fibre diameter may be in the range from 0.01 mm to 0.1 mm, more preferably 0.03 mm to 0.07 mm. The fibre length is not particularly limited. Short fibres having a length (e.g. number average length, e.g. determined by microscope counting of a representative sample of fibres) of about 0.3 mm may be particularly suitable, e.g. in the range from 0.1-1 mm. Longer fibres, e.g. up to about 50 mm may also be suitable. Fibres may be formed into pads or papers using techniques known to the skilled person such as wet laying.

Where the support is a granule or powder, typical number average particle diameters (e.g. determined by microscope counting of a representative sample of particles, e.g. taking the maximum particle dimension as the diameter) are in the range from 0.1 mm to 0.5 mm, but this is not particularly limited. For example, diameters ranging from 0.01 mm or 0.05 mm to 1 mm are suitable, although smaller and larger particles are also appropriate.

The solid support may be formed of polymer material, which may optionally be substantially non-porous. Suitable polymer materials include organic polymer materials. Particularly preferred are hydrocarbon polymers such as polyolefin materials. Particularly suitable polyolefins are polyethylene, polypropylene, polybutylene etc. Other hydrocarbon polymers such as polystyrene are also suitable. Alternative solid supports materials include silica.

It will be understood that in some cases it may be preferable to activate the surface of the support to facilitate immobilisation of the functional groups. Suitable surface activation techniques will be known to those skilled in the art, including for example plasma treatment, corona discharge and flame treatment.

Suitable adsorbents are available from Johnson Matthey Scavenging Technologies, and include Smopex® adsorbents, especially Smopex 111 and Smopex 112, and QuadraSil® adsorbents, especially QuadraSil-MP.

Preferably, following treatment in the methods of the present invention, the concentration of mercury in the treated solution is 0.1 ppm or less, 50 ppb or less, or 20 ppb or less, by weight of the mercury cyanide salt (e.g. K₂Hg(CN)₄). The feed to be treated may contain at least 0.5 ppm of mercury

Preferably, less than 20%, less than 10%, less than 5% or less than 1% by mass of the precious metal present in the aqueous feed solution is lost during the mercury removal process of the present invention.

### EXAMPLES

Adsorbent Materials

The below examples employ three different adsorbent materials:

| Adsorbent | Mercury Adsorbing Moiety | Support |
|---|---|---|
| 1 | 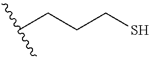 [SMILES: *CCCS] | Silica |
| 2 | 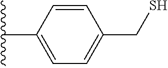 [SMILES: *c1ccc(CS)cc1] | Polyolefin |
| 3 | 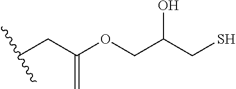 [SMILES: *CC(=C)OCC(O)CS] | Polyolefin |

Adsorbent 1 is available from Johnson Matthey Scavenging Technologies, product code TS-MP, or under the trade name QuadraSil-MP. Propylthiol functionalized silica is also available from Sigma Aldrich.

Adsorbent 2 is available as Smopex-111, from Johnson Matthey PLC—Scavenging Technologies. As used in the Examples, Adsorbent 2 was treated with NaOH to generate the sodium thiolate salt.

Adsorbent 3 is available as Smopex-112 from Johnson Matthey Scavenging Technologies.

Scavenging Test Protocol—Batch

For each solution tested, 0.5 wt % (dry weight) of adsorbent material was added to a test tube, along with 15 mL of the solution to be tested. The tubes were covered and stirred for two hours at room temperature, after which the solutions were filtered using Whatman 541 paper into an analysis vial. If required, the filtrate was centrifuged (5 min, 5000 rpm) and/or filtered through a 0.45 μm filter. Inductively Coupled Plasma elemental analysis was carried out on all solutions, including in each case a sample of the original, untreated solution as tested.

### Example 1

### Adsorption of Mercury and Gold from a Model Solution at Differing pH

Model solutions comprising 4 ppm Au and 1 ppm Hg were prepared by adding K₂Hg(CN)₄ and KAu(CN)₂ to water, together with a suitable quantity of NaOH to give the desired pH. In these solutions, ppm is by mass with respect to the metal ion. For example, 100 ppm Hg would be made by dissolving 190.9 mg of K₂Hg(CN)₄ in 1 L of water.

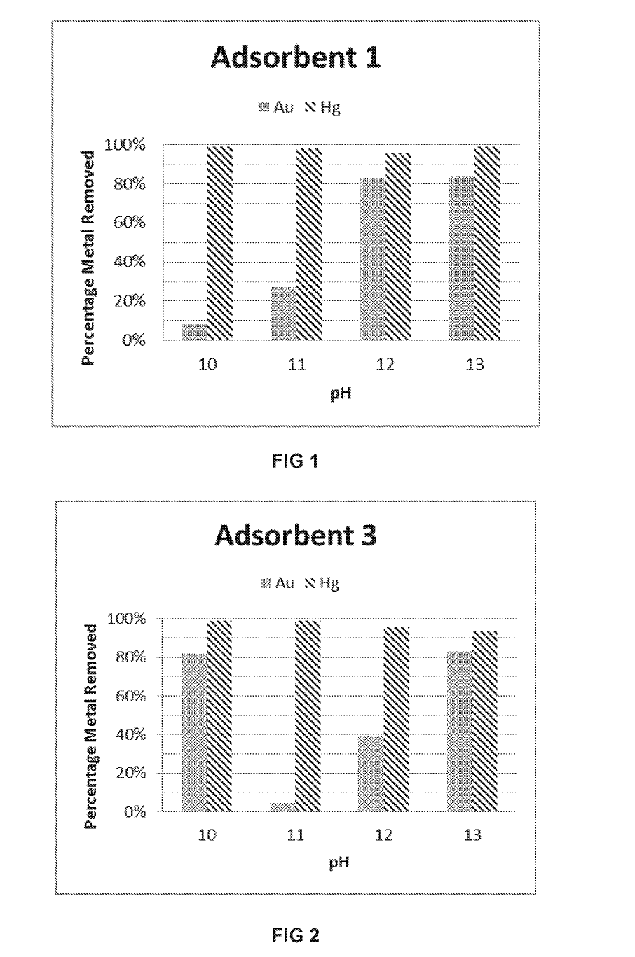

Adsorption of Au and Hg by adsorbents 1 and 3 at pHs 10, 11, 12 and 13 was investigated, using the batch scavenging test protocol described above. The results are shown in FIGS. 1 and 2. The results show that the two adsorbents exhibited excellent adsorption of Hg, but that significant quantities of Au were adsorbed, particularly at pHs 12 and 13 for Adsorbent 1, and pHs 10, 12 and 13 for Adsorbent 2.

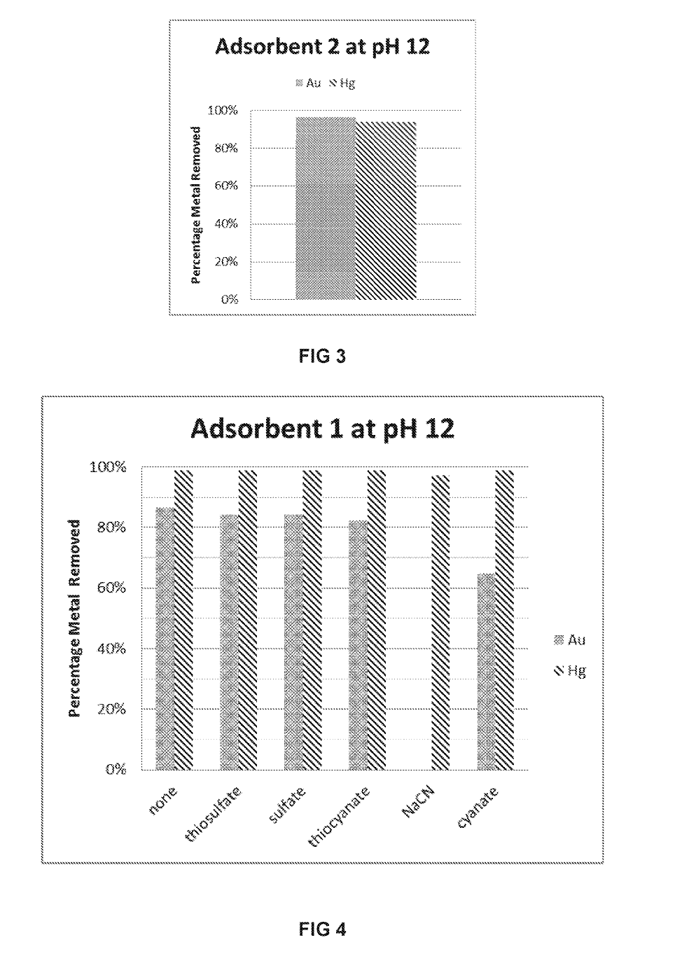

Adsorption of Au and Hg by Adsorbent 2 at pH 12 was investigated, using the batch scavenging test protocol described above. The results are shown in FIG. 3. The results show that Adsorbent 2 exhibits excellent adsorption of Hg, but that significant quantities of Au were also adsorbed.

### Example 2

### Adsorption of Mercury and Gold in the Presence of Additives

Model solutions comprising 4 ppm Au and 1 ppm Hg were prepared by adding K₂Hg(CN)₄ and KAu(CN)₂ to water, together with a suitable quantity of NaOH to give pH12, and 100 ppm of one of the additives listed below. In these solutions, ppm is by mass with respect to the metal ion.

Additives

Thiosulfate
Sulfate
Thiocyanate
Sodium Cyanide
Cyanate

The effect of 100 ppm of these additives was investigated for Adsorbent 1 and 3, using the batch scavenging test protocol described above. The results are shown in FIGS. 4 and 5. They demonstrate that the none of the additives had a great effect on Hg adsorption. However, the presence of sodium cyanide reduced Au adsorption to almost zero, for both adsorbent materials. This suggests that the presence of cyanide in the solutions reduces the adsorption of Au.

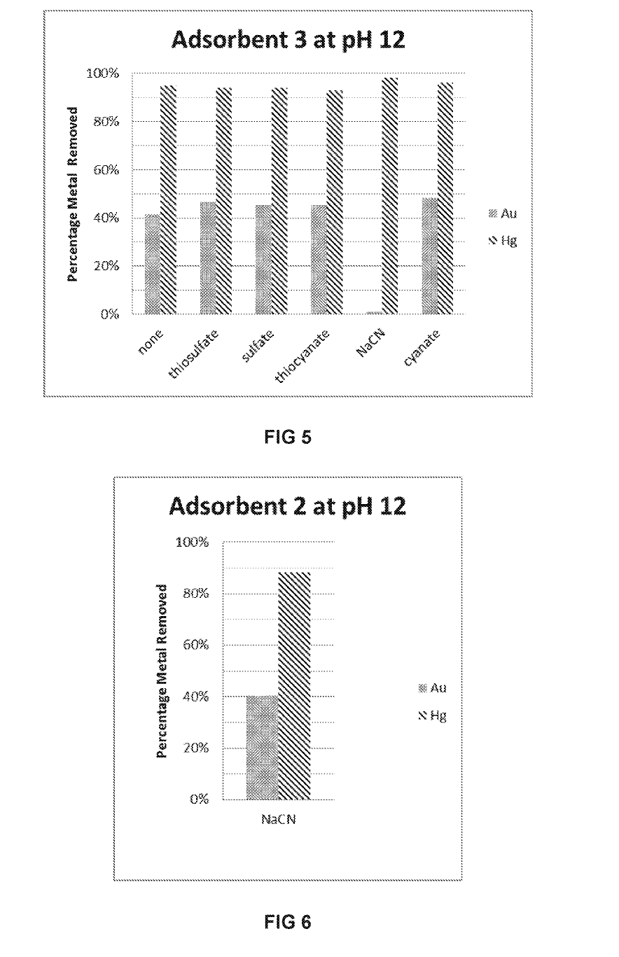

The effect of the presence of 100 ppm sodium cyanide was also investigated for Adsorbent 3, using the batch scavenging test protocol described above. A model solution comprising 4 ppm Au and 1 ppm Hg (prepared by adding K₂Hg(CN)₄ and KAu(CN)₂ to water) together with a suitable quantity of NaOH to give pH12, and 100 ppm of sodium cyanide was used. The results are shown in FIG. 6. The results show that the amount of Au adsorbed is reduced by over 50% in the presence of 100 ppm sodium cyanide (compare with FIG. 3). This again suggests that the presence of cyanide in the solutions reduces the adsorption of Au.

### Example 3

### Adsorption of Mercury and Gold in the Presence of Nickel

The effect of the presence of nickel in the model solutions was investigated, as nickel is typically present in real samples solutions to be treated from gold mines. Model solutions comprising 4 ppm Au and 1 ppm Hg were prepared by adding K₂Hg(CN)₄ and KAu(CN)₂ to water, together with a suitable quantity of NaOH to give pH12, and 1, 100 or 600 ppm of Ni as K₂Ni(CN)₄. In these solutions, ppm is by mass with respect to the metal ion.

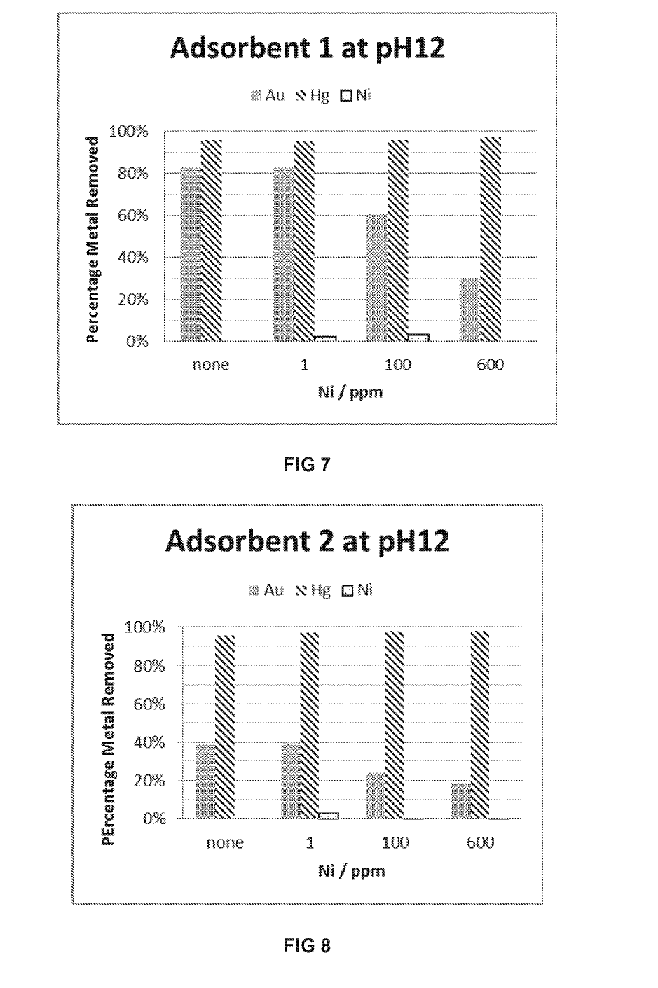

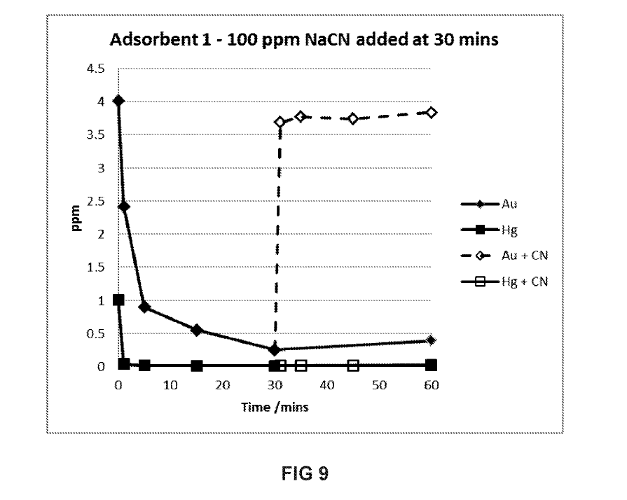

The adsorption of Hg, Au and Ni from these solutions was investigated for Adsorbents 1 and 3, using the batch scavenging test protocol described above. The results are shown in FIGS. 7 and 8. The results show that nickel is not removed by the adsorbents to a great extent. Increasing the quantity of K₂Ni(CN)₄ appeared to reduce Au adsorption. Without wishing to be bound by theory, the present inventors consider that this may be due to an increase in the effective cyanide concentration in the solution, e.g. because cyanide ions from the nickel cyanide complex are readily exchanged.

### Example 4

### Desorption of Gold with Sodium Cyanide Addition

Model solutions comprising 4 ppm Au and 1 ppm Hg were prepared by adding K₂Hg(CN)₄ and KAu(CN)₂ to water, together with a suitable quantity of NaOH to give pH12. Adsorption of Hg and Au by Adsorbent 1 from these model solutions was investigated using the batch scavenging test protocol described above. Samples of solution were tested using ICP at 1, 5, 15, 30 and 60 minutes following addition of the adsorbent. In one sample, 100 ppm NaCN was added after 30 minutes.

The results are shown in FIG. 9. They clearly show that on addition of NaCN, adsorbed Au is desorbed from the adsorbent, but Hg is not desorbed.

### Example 5

### Adsorption from a Real Mining Feed

To confirm that the advantageous adsorption behaviour observed for model solutions is also provided in real mining solutions, which may typically include more components, an actual mining solution produced in a gold cyanidation process was tested. The solution included both Hg and Au. Batch testing was carried out using each of Adsorbents 1, 2 and 3, using the batch scavenging test protocol described above.

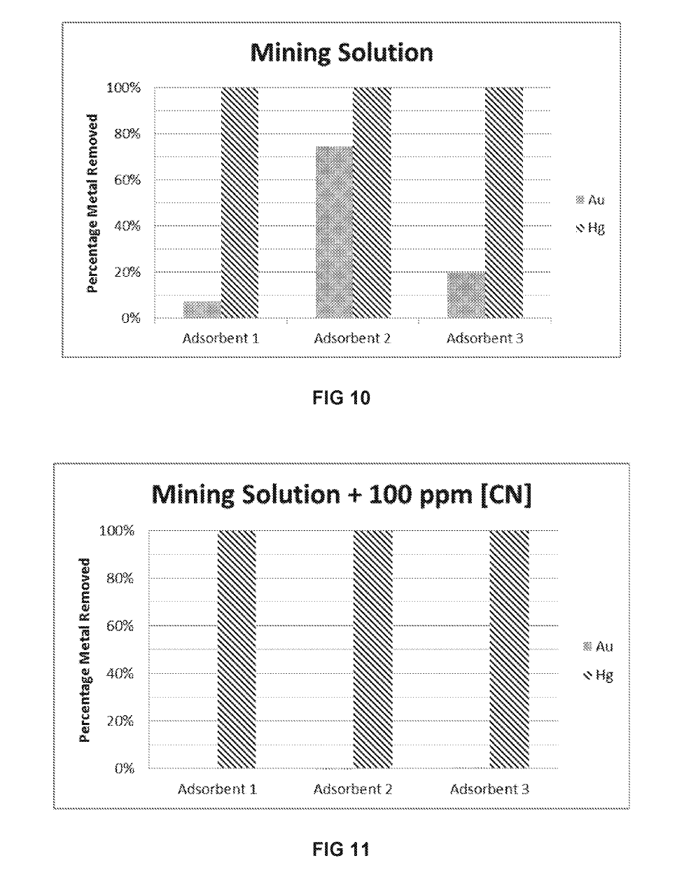

The results are shown in FIGS. 10 and 11. The results demonstrate that in the absence of cyanide, significant amounts of Au are adsorbed from the mining solution by each of the adsorbents tested. However, for solutions comprising 100 ppm NaCN, very little Au was adsorbed, whereas a very high level of Hg adsorption was achieved. This demonstrates the utility of the invention in treating real life mining solutions produced in the gold cyanidation process to remove Hg without loss of Au.

### Example 6

### Adsorption of Gold, Silver and Mercury

A model solution comprising 60 ppm Hg, 20 ppm Au, 15 ppm Ag and 850 ppm NaCN was prepared by adding K₂Hg(CN)₄, KAu(CN)₂, KAg(CN)₂ and NaCN to water, together with a suitable quantity of NaOH to give pH12. Adsorption from this solution using Adsorbent 1 was investigated using the batch scavenging test protocol described above.

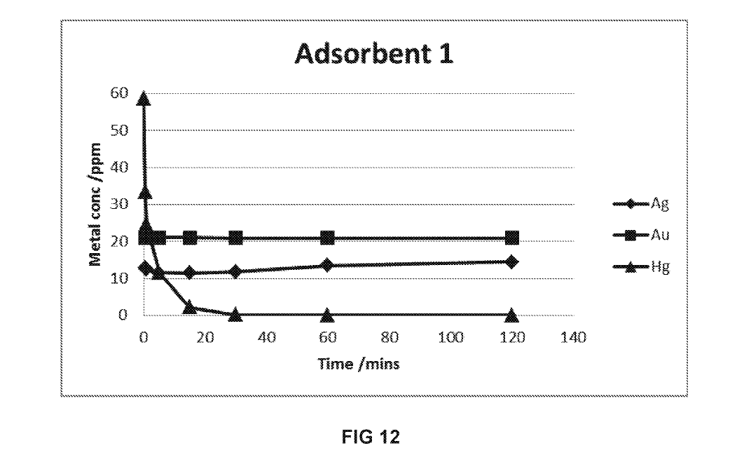

The results are shown in FIG. 12. The results show that substantially all of the Hg was adsorbed from this solution, but that very little of the Au and Ag was adsorbed. These results illustrate that the present invention is applicable to solutions comprising mercury in addition to precious metals other than gold.

### Example 7

### Column Adsorption of Mercury and Gold

Model solutions were passed through a column. The adsorbent was pre-treated with 6 bed volumes of NaOH prior to the adsorption tests. The adsorbent was then loaded with the 18 bed volumes of the model solution to be tested. A wash was then carried out using 6 bed volumes of NaOH. Elution (where carried out) employed 100 ppm [CN]⁻ solution.

As the skilled person will understand, the “BV/h” means bed volumes per hour.

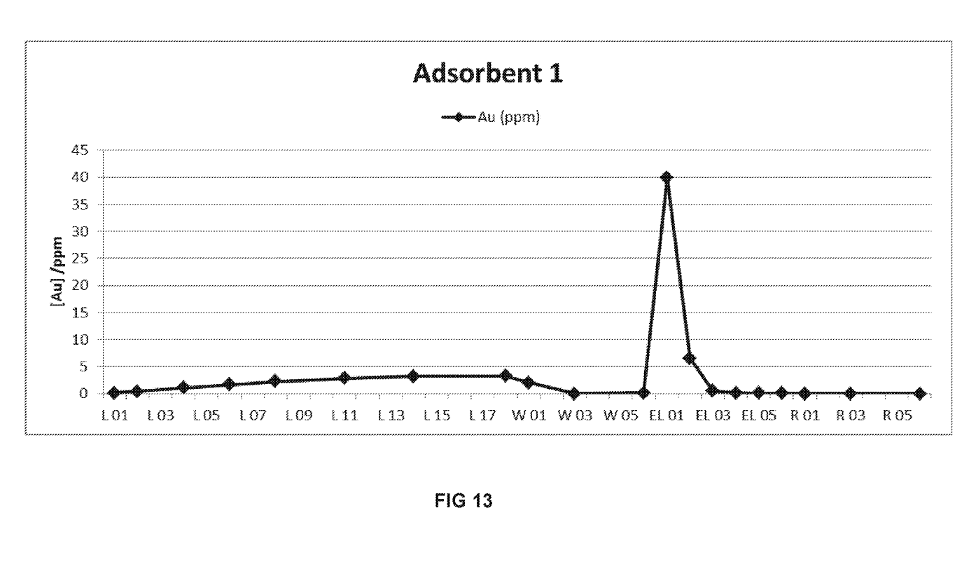

In FIGS. 13 to 16, Lxx indicates a sample taken during the loading phase, Wxx indicates a sample taken during the wash phase, Exx indicates a sample taken during the elution phase, and Rxx indicates a sample taken during the rinse phase. Samples were analysed using ICP.

The tests reported below all employ Adsorbent 1 in a column.

Test A

The model solution comprised 5 ppm Au, and a flow rate of 1 BV/h was used. Elution was carried out using 100 ppm NaCN solution. The results are shown in FIG. 13, and demonstrate that the gold is readily loaded onto the adsorbent, and readily eluted with NaCN solution.

Test B

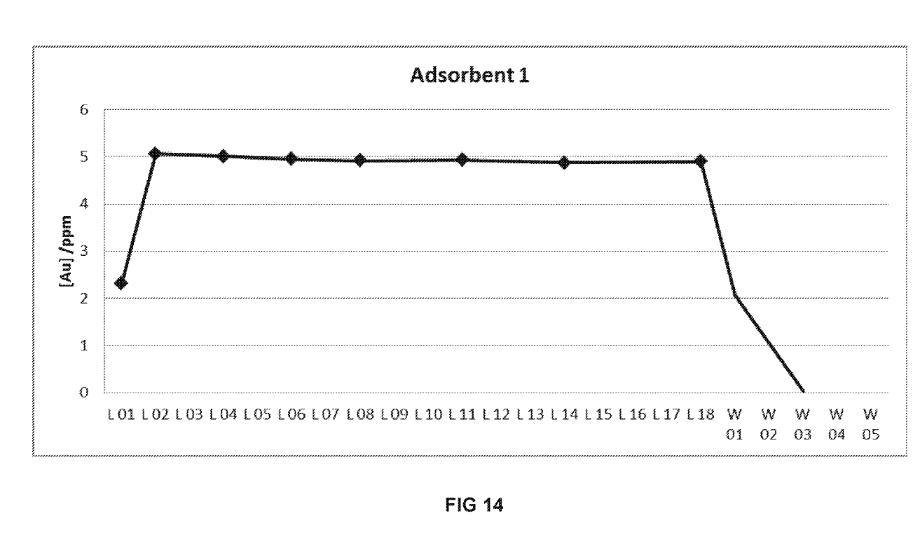

The model solution comprised 5 ppm Au and 100 ppm cyanide. A flow rate of 1 BV/h was used. The results are shown in FIG. 14 and show that gold is not adsorbed to any significant extent in the presence of 100 ppm NaCN.

Test C

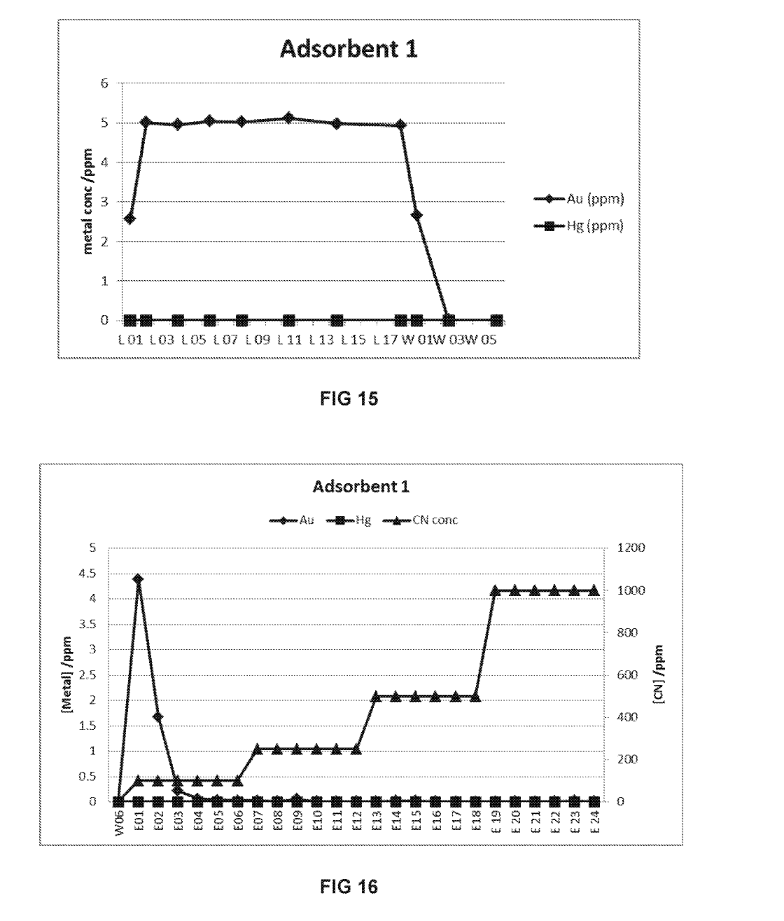

The model solution comprised 4.90 ppm Hg, 4.99 ppm Au and 100 ppm cyanide. A flow rate of 6 BV/h was used. The results are shown in FIG. 15, and demonstrate that gold is not adsorbed to a significant extent, and substantially all of the mercury is adsorbed.

Test D

The model solution comprised 5.07 ppm Hg and 5.10 ppm Au. A flow rate of 6 BV/h was used. Elution was carried out with cyanide solution of varying concentration (100 ppm, 200 ppm, 500 ppm and 1000 ppm). The results are shown in FIG. 16 and demonstrate that gold is readily eluted with 100 ppm, but that mercury is not eluted even with 1000 ppm.

### REFERENCES

1. Miller, J. D., Alfaro, E., Misra, M., & Lorengo, J. (1996). Mercury control in the cyanidation of gold ores. Pollution Prevention for Process Engineers, Engineering Foundation, 151-64

2. Tassell F. et al (1997). Removal of Mercury from Gold Cyanide Solution by Dissolved air Flotation, Minerals Engineering, Vol. 10, No. 8, 803-811

3. Metlock et al (200). Advanced Mercury Removal from Gold Leachate Solutions Prior to Gold and silver Extraction: A Field Study from an Active Gold Mine in Peru, Envirn. Sci. Technol. 2002, 36, 1636-1639

1. A process for selectively removing mercury from an aqueous feed solution, the aqueous feed solution comprising mercury in addition to one or more precious metals, wherein the process comprises contacting the aqueous feed solution with a solid sorbent material comprising thiol and/or thiolate functional groups, wherein
(i) the aqueous feed solution comprises at least 10 ppm of free cyanide ions; and/or
(ii) the sorbent material is contacted with an aqueous cyanide solution after contact with the aqueous feed solution to selectively desorb precious metal from the sorbent material.

2. A process according to claim 1 wherein the precious metal present in the aqueous feed solution is one or both of gold and silver.

3. A process according to claim 1 wherein the mercury is present as a mercury cyanide complex and each precious metal is present as a precious metal cyanide complex.

4. A process according to claim 1 wherein the aqueous feed solution comprises at least 30 ppm of free cyanide ions.

5. A process according to claim 1 wherein the aqueous cyanide solution comprises at least 30 ppm of cyanide ions.

6. A process according to claim 1 wherein the process further comprises the step of adding cyanide ions to the aqueous feed solution.

7. A process according to claim 1 wherein the aqueous feed solution has a pH in the range from 9 to 13.

8. A process according to claim 1 where in the sorbent material comprises mercury adsorbing moieties comprising thiol or thiolate functional groups, immobilised on a solid support.

9. A process according to claim 8 wherein the mercury adsorbing moieties have a structure according to Formula I or Formula II below: 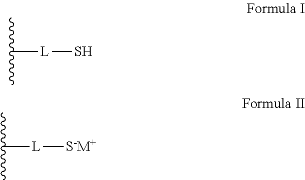
in which L is a linker group, and M⁺ is a counter ion.

10. A process according to claim 9 wherein L is selected from:
—R₁—, wherein R₁ is C₁ to C₁₅ (e.g. C₁ to C₁₀ or C₁ to C₅) straight or branched, optionally substituted alkylene or alkenylene moiety;
—R₂—X—R₂—, wherein each R₂ is independently C₁ to C₁₀ (e.g. C₁ to C₅) straight or branched, optionally substituted alkylene or alkenylene moiety and wherein X is selected from O and S; and
—R₃—Y—R₃—, wherein each R₃ is independently present or absent and when present is independently selected from C₁ to C₁₀ (e.g. C₁ to C₅) straight or branched, optionally substituted alkylene or alkenylene moiety, and —R₄—X—R₄— wherein each R₄ is independently C₁ to C₅ (e.g. C₁ to C₃) straight or branched, optionally substituted alkylene or alkenylene moiety, wherein Y is selected from cycloalkylene, cycoalkenylene, arylene, in which one or more ring carbon atoms are replaced by a heteroatom selected from O, N and S, and wherein X is selected from O and S.

11. A process according to claim 8 wherein the mercury adsorbing moieties have a structure according to one of Formula III, Formula IV or Formula IV below: 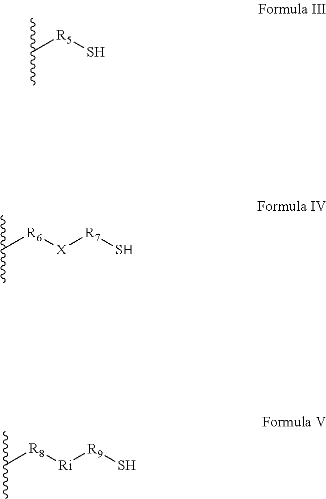
wherein:
each of R₅, R₆, and R₇, is independently C₁ to C₁₀ (e.g. C₁ to C₅) straight or branched alkylene or alkenylene, optionally substituted with up to four functional groups selected from —OR₁₀, —SR₁₀, —S⁻M⁺ and —NR₁₀R₁₀;
each R₈ and R₉ is independently selected from R₁₁—X—R₁₁ and C₁ to C₁₀ (e.g. C₁ to C₅) straight or branched alkylene or alkenylene, optionally substituted with up to four functional groups selected from —OR₁₀, —SR₁₀, —S⁻M⁺ and —NR₁₀R₁₀;
each R₁₀ is independently H or C₁ to C₅ alkyl;
each R₁₁ is independently C₁ to C₅ straight or branched alkylene or alkenylene, optionally
substituted with up to four functional groups selected from —OR₁₀, —SR₁₀, —S⁻M⁺ and —NR₁₀R₁₀;
Ri is a C₅ or C₆ cycloalkyl, cycloalkenyl or aryl ring;
X is S or O;
R₈ may optionally be absent;
R₉ may optionally be absent; and
any SH group may instead be S⁻M⁺, wherein M is a counter ion.

12. A process according to claim 8 wherein the mercury adsorbing moieties have a structure according to one of Formula VI, Formula VII or Formula VIII below: 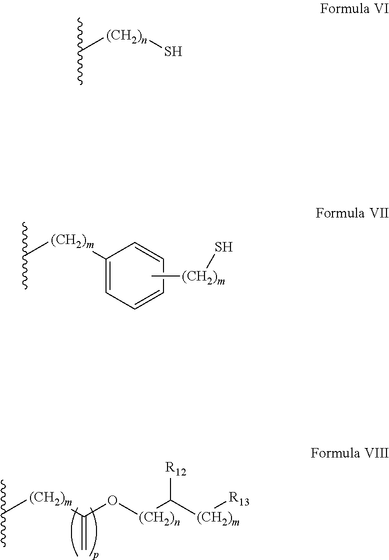
wherein:
each n is independently 1 to 10;
each m is independently 0 to 10;
R₁₂ and R₁₃ are each independently selected from SH, NH₂ or OH, provided that at least one of R₅ and R₆ is SH;
p is 0 or 1; and
any SH group may instead be S⁻M⁺ wherein M is a counter ion.

13. A process according to claim 1 wherein the mercury adsorbing moieties are selected from

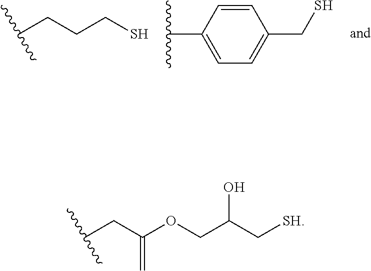

14. A process according to claim 1 wherein after contact with the sorbent material the concentration of mercury in the treated aqueous feed solution is 50 ppb or less.

15. A process according to claim 1 wherein less than 5% by mass of the precious metal present in the aqueous feed solution is lost during process.

16. A method of removing selectively removing mercury from an aqueous feed solution comprising applying an effective amount of a sorbent material comprising thiol and/or thiolate functional groups.

17. A process according to claim 2 wherein the mercury is present as a mercury cyanide complex and each precious metal is present as a precious metal cyanide complex.

18. A process according to claim 2 wherein the aqueous feed solution comprises at least 30 ppm of free cyanide ions.

19. A process according to claim 3 wherein the aqueous feed solution comprises at least 30 ppm of free cyanide ions.

20. A process according to claim 2 wherein the aqueous cyanide solution comprises at least 30 ppm of cyanide ions.
